(19) United States
(12) Patent Application Publication
(10) Pub. No.: US 2024/0187175 A1
(43) Pub. Date: Jun. 6, 2024

(54) TRANSMISSION OF A NEW RADIO DOWNLINK DATA CHANNEL AND CONFIGURATION OF LTE-CRS RATE MATCHING

(71) Applicant: Telefonaktiebolaget LM Ericsson (publ), Stockholm (SE)

(72) Inventors: Saad Naveed Ahmed, SUNDBYBERG (SE); Karl Mann, Ottawa Ontario (CA)

(21) Appl. No.: 18/285,486

(22) PCT Filed: Apr. 30, 2021
(86) PCT No.: PCT/SE2021/050404

§ 371 Date: Oct. 3, 2023

(51) Int. Cl. H04L 5/00; H04B 7/06; H04L 1/00; H04W 72/0446

(52) U.S. Cl. CPC H04L 5/005; H04L 1/0013; H04W 72/0446; H04B 7/0626

(57) ABSTRACT

There is provided mechanisms for transmission of an NR downlink data channel in a slot. A method is performed by a network node. The method comprises establishing a network connection for an NR user equipment over an NR air interface and configuring the NR user equipment with less than full LTE-CRS rate matching. The method comprises configuring resource elements for NR transmission and resource elements for LTE transmission in the slot. The NR data is allocated to the resource elements for NR transmission that correspond to the NR downlink data channel. Any resource elements for LTE transmission that correspond to the NR downlink data channel are to be muted. The method comprises initiating transmission of the slot.

### TECHNICAL FIELD

Embodiments presented herein relate to a method, a network node, a computer program, and a computer program product for transmission of a New Radio downlink data channel in a slot.

### BACKGROUND

NR (New Radio) is the air interface specified for the fifth generation (5G) telecommunications systems according to the third generation partnership project (3GPP). NR might be regarded as a further development, with enhanced functionality and performance, of the Long Term Evolution (LTE) air interface.

Mobile network operators that deploy NR typically have access to, or have been allocated, existing frequency spectrum on multiple frequency bands where LTE signalling is currently deployed. Initially, the fraction of NR capable user equipment might be limited compared to LTE capable user equipment and therefore a large part of the existing frequency spectrum might still need to be allocated for LTE signalling.

There are several architecture options for how to deploy NR together with LTE.

One option is to use LTE as the main air interface whilst NR is added using dual connectivity in non-standalone mode. With dual connectivity, both the LTE air interface and the NR air interface can be used in parallel for data transmission (and reception). In the downlink (i.e., in the direction from radio access network node on the network side towards user equipment on the user side) the data transmission is split at the Packet Data Convergence Protocol (PDCP) layer and can use either one of the air interfaces (i.e., LTE or NR) or both. In uplink (i.e., in the direction from user equipment on the user side towards radio access network node on the network side) the data received from the two air interfaces are combined in the PDCP layer at the radio access network node.

To have an efficient frequency spectrum utilization, it is possible to overlay an NR carrier in the same frequency spectrum as an LTE carrier. This is made possible by flexible locations of control channels and signals, and by rate matching around common reference signals (CRS) and synchronization signals (such as primary synchronization signals (PSSs), secondary synchronization signals (SSSs)), and physical broadcast channel (PBCH) that are always transmitted in an LTE carrier. Hence, different CRS port configurations could be used for such rate matching.

FIG. 1 illustrates time/frequency resources in time/frequency resource grids 10 and 20 for transmission of CRSs using a CRS port configurations of two antenna ports; “Antenna port 0” and “Antenna port 1”. As can be seen in the figure, no transmission is allowed on “Antenna port 0” for those resource elements used for LTE CRS resource elements (RE) that are transmitted on “Antenna port 1” and vice versa. This principle holds also in case there are more than two antenna ports.

LTE-CRS Rate Matching (CRS-RM) might be used for NR user equipment to avoid interference from LTE-CRS REs. In short, for NR downlink data transmission, rate matching can be used to avoid transmission on the REs occupied by LTE CRS. In this case, the NR downlink data transmission can be spread around the LTE CRS both in time and frequency domain by making use of rate matching around REs occupied by the LTE CRS. CRS-RM thus comes with an overhead as useful REs for NR are wasted by being used for avoiding interference to the LTE CRS, instead of being used for carrying useful data. The reduced number of REs available for carrying data for the NR user equipment also lowers the maximum reachable modulation and coding scheme (MCS) for the NR user equipment. In general terms, the higher the number of LTE CRSs, the higher the overhead will be and the lower the number of REs available for carrying data for the NR user equipment will be.

Further, if an NR user equipment does not support CRS-RM, it might not be served on a shared carrier.

Hence, there is still a need for improved joint downlink NR and LTE transmissions.

### SUMMARY

An object of embodiments herein is to provide efficient joint downlink NR and LTE transmission that does not suffer from the issues noted above, or at least where the issues noted above are mitigated or reduced.

According to a first aspect there is presented a method for transmission of an NR downlink data channel in a slot. The method is performed by a network node. The method comprises establishing a network connection for an NR user equipment over an NR air interface and configuring the NR user equipment with less than full LTE-CRS rate matching. The method comprises configuring resource elements for NR transmission and resource elements for LTE transmission in the slot. The NR data is allocated to the resource elements for NR transmission that correspond to the NR downlink data channel. Any resource elements for LTE transmission that correspond to the NR downlink data channel are to be muted. The method comprises initiating transmission of the slot.

According to a second aspect there is presented a network node for transmission of an NR downlink data channel in a slot. The network node comprises processing circuitry. The processing circuitry is configured to cause the network node to establish a network connection for an NR user equipment over an NR air interface and configuring the NR user equipment with less than full LTE-CRS rate matching. The processing circuitry is configured to cause the network node to configure resource elements for NR transmission and resource elements for LTE transmission in the slot. The NR data is allocated to the resource elements for NR transmission that correspond to the NR downlink data channel. Any resource elements for LTE transmission that correspond to the NR downlink data channel are to be muted. The processing circuitry is configured to cause the network node to initiate transmission of the slot.

According to a third aspect there is presented a network node for transmission of an NR downlink data channel in a slot. The network node comprises an establish module (210a) configured to establish a network connection for an NR user equipment over an NR air interface and configuring the NR user equipment with less than full LTE-CRS rate matching. The network node comprises a configure module configured to configure resource elements for NR transmission and resource elements for LTE transmission in the slot. The NR data is allocated to the resource elements for NR transmission that correspond to the NR downlink data channel. Any resource elements for LTE transmission that correspond to the NR downlink data channel are to be muted. The network node comprises an initiate module configured to initiate transmission of the slot.

According to a fourth aspect there is presented a computer program for transmission of an NR downlink data channel in a slot, the computer program comprising computer program code which, when run on a network node, causes the network node to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient joint downlink NR and LTE transmission.

Advantageously, these aspects provide joint downlink NR and LTE transmission that does not suffer from the issues noted above.

Advantageously, these aspects enable NR user equipment which do not support LTE-CRS rate matching to be eligible for inclusion to operate on shared spectrum channels.

Advantageously, these aspects enable a capacity increase for the NR downlink data channel.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates transmission of CRSs;

FIG. 2 is a schematic diagram illustrating a communications network according to embodiments;

FIG. 3 is a flowchart of methods according to embodiments;

FIG. 4 schematically illustrates a block diagram of a network node according to an embodiment;

FIG. 5 is a signalling diagram according to an embodiment;

FIG. 6 schematically illustrates parts of a subframe according to an embodiment;

FIG. 7 is a schematic diagram showing functional units of a network node according to an embodiment;

FIG. 8 is a schematic diagram showing functional modules of a network node according to an embodiment;

FIG. 9 shows one example of a computer program product comprising computer readable storage medium according to an embodiment;

FIG. 10 is a schematic diagram illustrating a telecommunication network connected via an intermediate network to a host computer in accordance with some embodiments; and

FIG. 11 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

FIG. 2 is a schematic diagram illustrating a communications network 100 where embodiments presented herein can be applied. The communications network 100 comprises a network node 200 configured to provide network access to user equipment, as represented by user equipment 150a,150b, 150c, in a radio access network 110. The radio access network 110 is operatively connected to a core network 120. The core network 120 is in turn operatively connected to a service network 130, such as the Internet. The user equipment 150a,150b, 150c are thereby enabled to, via the network node 200, access services of, and exchange data with, the service network 130. Some of the user equipment 150a,150b, 150c might be configured to communicate with the network node 200 using LTE signalling, some of the user equipment 150a,150b, 150c might be configured to communicate with the network node 200 using NR signalling, and some of the user equipment 150a,150b, 150c might be configured to communicate with the network node 200 using both LTE signalling and NR signalling. User equipment 150a,150b, 150c configured to communicate with the network node 200 using LTE signalling are hereinafter denoted LTE user equipment. User equipment 150a,150b, 150c configured to communicate with the network node 200 using NR signalling are hereinafter denoted NR user equipment. User equipment 150a,150b, 150c configured to communicate with the network node 200 using both LTE signalling and NR signalling are hereinafter denoted LTE/NR user equipment.

The network node 200 comprises, is collocated with, is integrated with, or is in operational communications with, an antenna system comprising co-sited antenna arrays 140a, 140b. Each of the antenna arrays 140a, 140b might comprise a plurality of individual antennas, or antenna elements. In some implementations, one antennas antenna array 140a might be configured for LTE signalling whereas the other antennas antenna array 140b might be configured for NR signalling. In other implementations, both antenna arrays 140a, 140b are configured for both LTE signalling and NR signalling.

Examples of network nodes 200 are radio access network nodes, radio base stations, base transceiver stations, Node Bs, evolved Node Bs, gNBs, access points, access nodes, and backhaul nodes. Examples of user equipment 150a,150b, 150c are terminal devices, wireless devices, mobile stations, mobile phones, handsets, wireless local loop phones, smartphones, laptop computers, tablet computers, network equipped sensors, network equipped vehicles, and so-called Internet of Things devices.

As noted above there is still a need for improved joint downlink NR and LTE transmissions.

According to at least some of the herein disclosed embodiments there is therefore proposed methods that remove inefficiencies for NR user equipment created by LTE-CRS-RM in a system where the spectrum is shared between the NR air interface and the LTE air interface. The herein disclosed embodiments enable a reduction of the effect of LTE CRS as overhead to the downlink signals and channels for the NR user equipment, whilst also handling any potential impact to the performance of LTE user equipment.

The embodiments disclosed herein in particular relate to mechanisms for transmission of an NR downlink data channel in a slot. In order to obtain such mechanisms there is provided a network node 200, a method performed by the network node 200, a computer program product comprising code, for example in the form of a computer program, that when run on a network node 200, causes the network node 200 to perform the method.

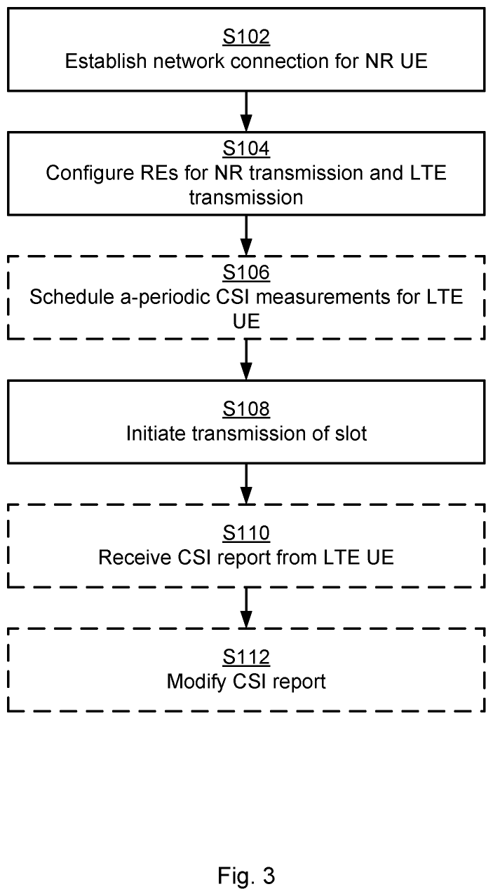

FIG. 3 is a flowchart illustrating embodiments of methods for transmission of an NR downlink data channel in a slot. The methods are performed by the network node 200. The methods are advantageously provided as computer programs 920.

S102: The network node 200 establishes a network connection for an NR user equipment 150a over an NR air interface. The network node 200 configures the NR user equipment 150a with less than full LTE-CRS rate matching.

S104: The network node 200 configures resource elements for NR transmission and resource elements for LTE transmission in the slot. The NR data is allocated to the resource elements for NR transmission that correspond to the NR downlink data channel. Any CRS resource elements for LTE transmission that correspond to the NR downlink data channel are to be muted.

S108: The network node 200 initiates transmission of the slot.

Embodiments relating to further details of transmission of an NR downlink data channel in a slot as performed by the network node 200 will now be disclosed.

In some aspects, the same carriers and/or the same bandwidth is used for both LTE transmissions and NR transmissions. Therefore, in some embodiments, the LTE transmission and the NR transmission are initiated on the same carrier and/or within the same bandwidth interval.

There may be different ways in which the NR user equipment 150a is configured with less than full LTE-CRS rate matching. Whenever a network connection is established for a NR user equipment 150a, the NR user equipment 150a is either not configured with LTE-CRS rate matching at all or configured with only limited LTE-CRS rate matching. Hence, in some embodiments, the less than full LTE-CRS rate matching corresponds to no LTE-CRS rate matching or LTE-CRS rate matching in less than all available physical resource blocks (PRBs). In some examples, the configuring in step S102 is performed using radio resource control (RRC) signalling. Hence, the network node 200 might configure the NR user equipment 150a with less than full LTE-CRS rate matching over RRC.

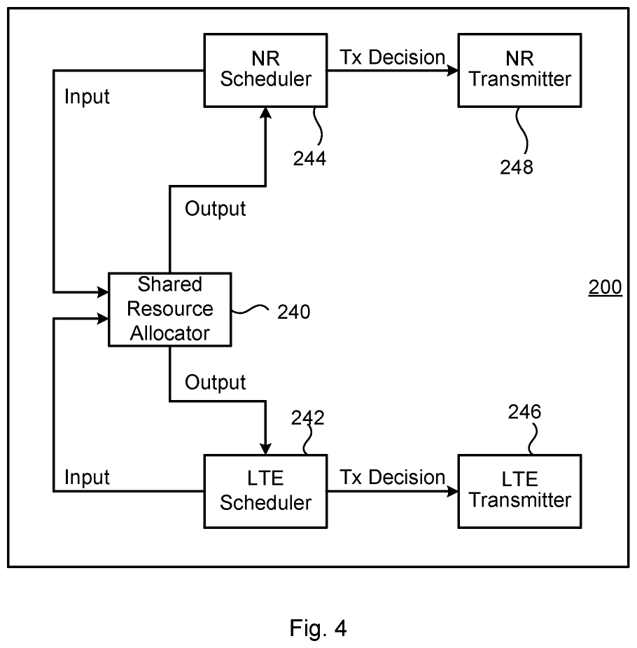

There could be different ways in which the transmission of the slot is initiated in step S108. In some aspects, as will be illustrated below with reference to FIG. 4, the transmission of the LTE control information is handled by an LTE scheduler and the transmission of the NR downlink data channel is handled by an NR scheduler. The transmission of the slot might therefore be initiated by providing information of the configured resource elements to the LTE scheduler and the NR scheduler. Hence, in some embodiments, the network node 200 is configured to perform any of the following (optional) steps as part of initiating the transmission of the slot in step S108:

The network node 200 provides information of the configured resource elements for the NR transmission to a scheduler of the NR transmission.

The network node 200 provides information of the configured resource elements for the LTE transmission to a scheduler of the LTE transmission.

These steps might be performed by a shared resource allocator of the network node 200.

In further embodiments, the network node 200 is configured to perform any of the following (optional) steps as part of initiating the transmission of the slot in step S108:
The network node 200 initiates, for a transmitter of the NR transmission, transmission of the NR data in at least one resource block corresponding to the NR downlink data channel. This step might be performed by an LTE scheduler of the network node 200.

The network node 200 initiates, for a transmitter of the LTE transmission, muting of LTE control information (such as CRS) in this at least one resource block. This step might be performed by an NR scheduler of the network node 200.

There could be different types of subframes in which the slot is transmitted. For example the subframe might be a Multicast-Broadcast Single-Frequency Network (MBSFN) subframe or even a non-MBSFN subframe. In some deployments, it may be advantageous to have the NR downlink data channel in non-MBSFN subframes, since the CRS can be muted, instead of the NR downlink data channel being protected in MBSFN subframes.

There could be different types of NR downlink data channels. In some examples, the NR downlink data channel is an NR Physical Downlink Shared Channel (PDSCH).

In general terms, the NR downlink data channel covers one or more PRBs, also denoted Carrier Resource Blocks (CRBs). In particular, in some embodiments, the NR downlink data channel covers a range of PRBs, and the resource elements for LTE transmission that correspond to the NR downlink data channel are to be muted only for the specified range of PRBs.

As disclosed above, any resource elements for LTE transmission that correspond to the NR downlink data channel are to be muted. Muting of the resource elements for LTE transmission might cause issues for the LTE user equipment if not handled properly. This since the LTE user equipment might use these resource elements for channel estimation, channel status reporting and cell measurements. Next will be disclosed some examples of how the impact of the muting can be mitigated to avoid network behavior changes for the LTE user equipment when muting resource elements for LTE transmission. In some aspects, different types of compensation schemes are utilized to mitigate any performance loss that the LTE user equipment might experience due to the muting of a symbol used for transmission of LTE control information.

One such mitigation scheme involves modifying channel state information (CSI) reports received from the LTE user equipment. In particular, in some embodiments, the network node 200 is configured to perform (optional) steps S110 and S112:

S110: The network node 200 receives a CSI report from an LTE user equipment 150b:150c over an LTE air interface. The channel state information report is based on measurements in the slot.

S112: The network node 200 modifies the CSI report.

Examples of how the CSI report might be modified will be disclosed next.

In some aspects, when only some PRBs are allocated to NR transmission in a slot and when the LTE user equipment are configured with periodic CSI measurements in the slot, any of the following mitigation actions might be performed. Firstly, higher weights could be given to measurements outside the PRBs allocated to the NR transmission. Secondly, measurements on muted CRSs could be ignored. Thirdly, higher weight might be given to reports on non-muted CRSs. Hence, in some embodiments, when the specified range of PRBs covers less than all PRBs, the modifying in step S112 comprises any of: increasing a weight assigned to the channel state information report when based on measurements outside the specified range of PRBs in the slot, ignoring any measurements in the channel state information report that depend on the resource elements for LTE transmission that are muted, increasing a weight assigned to the channel state information report when based on measurements that do not depend on the resource elements that correspond to the NR downlink data channel.

In further aspects, when some PRBs are allocated to NR transmission in a slot and some PRBs are allocated to LTE transmission in the slot, then the CSI reports corresponding to that slot can be used as follows. Firstly, in case the LTE user equipment reported sub-band CSI, the CSI of unmuted CRS sub-bands can be used to extrapolate the CSI to the muted CRS sub-bands. Secondly, in case the LTE user equipment reported only wide-band CSI, compensation can be performed according to the above disclosed modification of the CSI report.

In some aspects, when all PRBs are allocated to NR transmission in a slot and when the LTE user equipment are configured with periodic CSI measurements in slot, any of the following mitigation actions might be performed. Firstly, the CSI report might be ignored. Secondly, the CSI report might be given lower weight. Thirdly, the CSI report might be marked as having lower dependability. Hence, in some embodiments, when the specified range of PRBs covers all PRBs, the modifying in step S112 comprises any of: reducing a weight assigned to the channel state information report, ignoring the channel state information report, reducing dependability of the channel state information report.

Further, in some aspects, when all PRBs are allocated to NR transmission in a slot, then a-periodic CSI measurement might not be scheduled in such a slot. In particular, in some embodiments, the network node 200 is configured to perform (optional) step S106 when the specified range of PRBs covers all PRBs:

S106: The network node 200 schedules a-periodic channel state information measurements to be made by an LTE user equipment 150b:150c over an LTE air interface only outside the slot.

Another compensation scheme involves boosting transmission power of the LTE control information that is not muted.

That is, in some aspects, in order to compensate for muting of the transmission power of the LTE control information in one or more resource elements, the transmission power of the LTE control information in one or more other resource elements in the slot is boosted. That is, in some embodiments, the network node 200 is configured to perform any of the following (optional) step as part of initiating the transmission of the slot in step S108:

The network node 200 initiates boosting transmission power of LTE control information in at least one resource element for LTE transmission in the slot that does not correspond to the NR downlink data channel.

There could be different ways in which the transmission power is boosted. In some aspects, the boosting is proportional to the muting. That is, in some embodiments, how much the transmission power of the LTE control information is boosted is proportional to how much the transmission power of the resource elements for LTE transmission that correspond to the NR downlink data channel is muted.

There could be different ways for the network node 200 to obtain information that NR data is to be allocated to the resource elements for NR transmission that correspond to the NR downlink data channel. In some aspects, the information is defined by, is a result of, or otherwise depends on, a scheduling decision. That is, in some embodiments, that the NR downlink data channel is allocated to the resource elements for NR transmission that correspond to the NR downlink data channel is a result of a scheduling decision taken for the LTE transmission and the NR transmission.

In some aspects, the NR downlink data channel and the LTE control information is transmitted from co-sited antenna arrays 140a, 140b. In particular, in some embodiments, transmission of the subframe is, in step S108, initiated from co-sited antenna arrays 140a, 140b. The resource elements for LTE transmission and the resource elements for NR transmission are then to be transmitted from the co-sited antenna arrays 140a, 140b. In some aspects, both the NR downlink data channel and the LTE control information is transmitted from the same antenna. That is, in some embodiments, the resource elements of LTE transmission and the resource elements for NR transmission are combined on each antenna array 140a, 140b of the co-sited antenna arrays 140a, 140b. In other aspects, the LTE control information and the NR downlink data channel are transmitted from separate antennas. That is, in some embodiments, the resource elements for LTE transmission are transmitted from a first antenna array 140a of the co-sited antenna arrays 140a, 140b and the resource elements for NR transmission are transmitted from a second antenna array 140b of the co-sited antenna arrays 140a, 140b.

FIG. 4 schematically illustrates a block diagram of a network node 200 having a shared resource allocator 240, an LTE scheduler 242, and an NR scheduler 244, together with an LTE transmitter 246 and an NR transmitter 248. The LTE transmitter 246 might comprise, or be operatively connected to, at least the first antenna array 140a. The NR transmitter 248 might comprise, or be operatively connected to, at least the second antenna array 140b. The shared resource allocator 240 is configured to, based on input from the LTE scheduler 242 and the NR scheduler 244 take a decision in terms of configuring resource elements for transmission of LTE control information (such as CRS) and resource elements for transmission of a NR downlink data channel within the subframe, as in step S104. Transmission of the subframe, as in step S108, is initiated by the shared resource allocator 240 providing output to the LTE scheduler 242 and the NR scheduler 244.

The output defines which (or at least how many) resource elements in each subframe are configured for LTE transmission, in terms of LTE control information, and which (or at least how many) resource elements in each subframe are configured for NR transmission, in terms of the NR downlink data channel. The LTE scheduler 242 is configured to, based on the output received from the shared resource allocator 240, schedule the LTE transmission and initiate transmission of the LTE transmission from the LTE transmitter 246. The NR scheduler 244 is configured to, based on the output received from the shared resource allocator 240, schedule NR transmission and initiate transmission of the NR transmission from the NR transmitter 248.

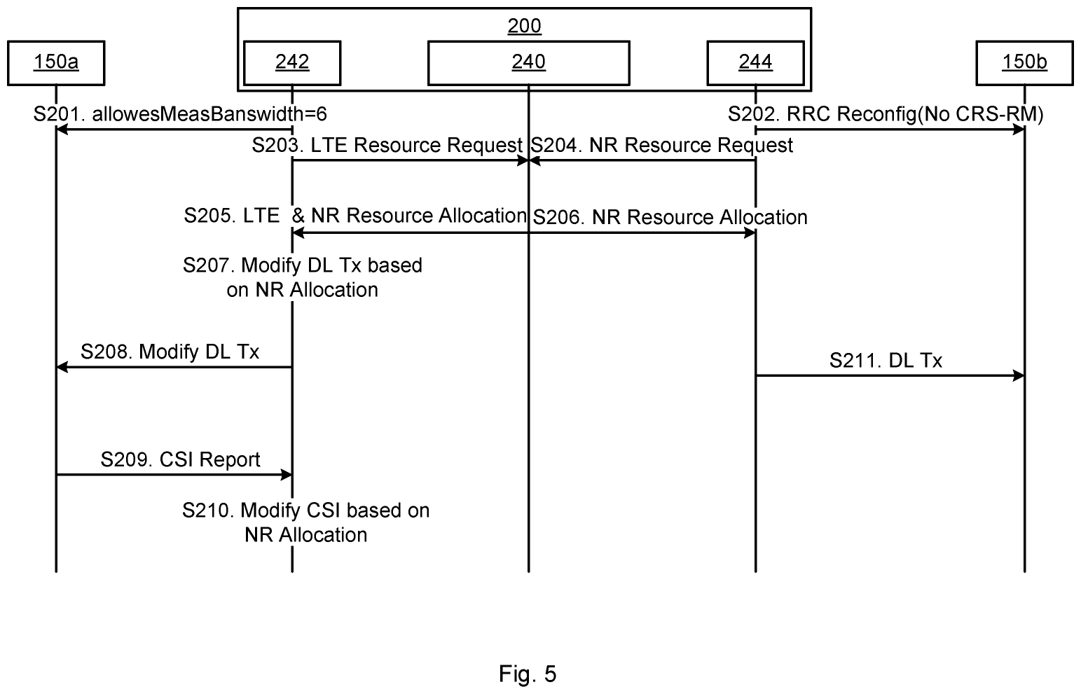

FIG. 5 is a signalling diagram for transmission of an NR downlink data channel in a slot as performed by the network node 200 according to at least some of the above disclosed embodiments.

S201: The LTE scheduler 242 configures LTE user equipment 150a with an allowed measurement bandwidth of 6 PRBs.

S202: The NR scheduler 244 configures NR user equipment 150b to not use (or at least limit the use of) LTE-CRS rate matching.

S203: The LTE scheduler 242 informs the shared resource allocator 240 that the LTE scheduler 242 has one or more LTE user equipment 150a that needs downlink scheduling resources in a scheduling TTI and hence provides an LTE resource requests to the shared resource allocator 240.

S204: The NR scheduler 244 informs the shared resource allocator 240 that the NR scheduler 244 has one or more NR user equipment 150b that needs downlink scheduling resources in a scheduling TTI and hence provides an NR resource requests to the shared resource allocator 240.

The LTE scheduler 242 and the NR scheduler 244 thus provide a respective demand to the shared resource allocator 240. The shared resource allocator 240 distributes the available resources between the LTE scheduler 242 and the NR scheduler 244. For example, the shared resource allocator 240 might distribute the available resources between the LTE scheduler 242 and the NR scheduler 244 based on Quality of Service (QOS) requirements.

S205: The shared resource allocator 240 notifies the LTE scheduler 242 of the resources, in terms of PRBs, allocated to the LTE scheduler 242 and the resources, in terms of PRBs, allocated to the NR scheduler 244.

S206: The shared resource allocator 240 notifies the NR scheduler 244 of the resources, in terms of PRBs, allocated to the NR scheduler 244.

S207: The LTE scheduler 242, based on the notification received from the shared resource allocator 240, modifies its downlink transmission towards the LTE user equipment 150a in accordance with the resources allocated to the NR scheduler 244.

S208: The LTE scheduler 242 schedules LTE transmission and instructs the downlink transmitter to mute CRS, i.e. not transmit CRS, on the symbols that can interfere with the resources allocated to the NR scheduler 244. The LTE scheduler 242 further initiates transmission of the LTE transmission towards the LTE user equipment 150a.

S209: The one or more LTE user equipment 150a transmit a respective CSI report.

S210: The network node 200 modifies the CSI report, as in step S112.

S211: The NR scheduler 244, based on the notification received from the shared resource allocator 240, schedules NR transmission and initiates transmission of the NR transmission towards the NR user equipment 150b.

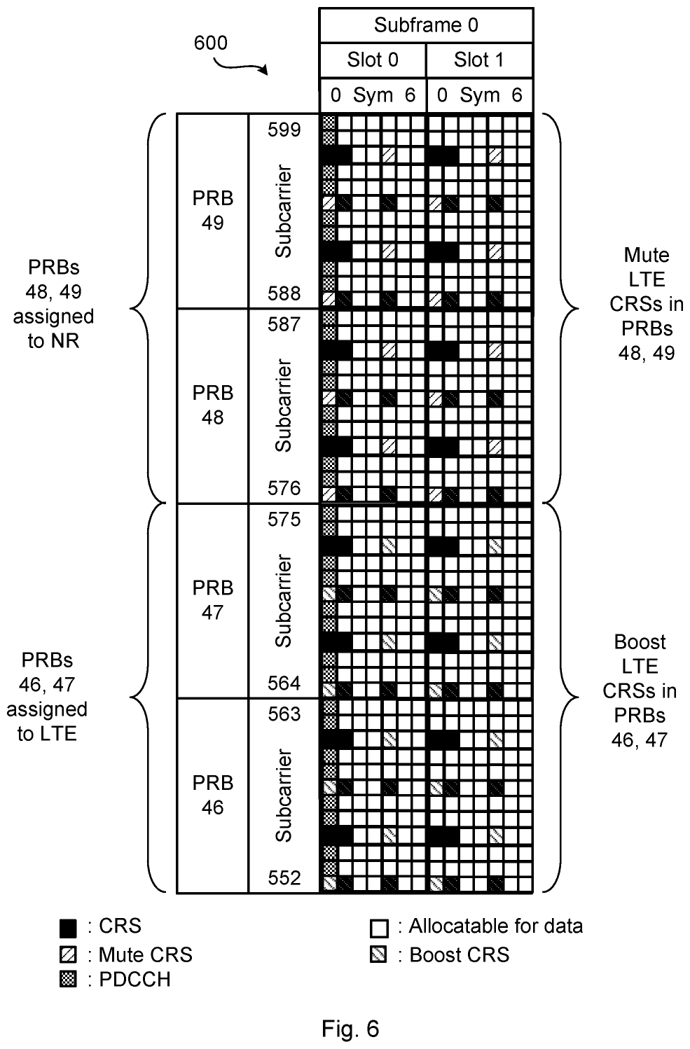

FIG. 6 schematically illustrates a time/frequency grid 600 for subcarriers 552 to 599 of a subframe comprising two slots; “Slot 0” and “Slot 1”, each consisting of 7 symbols (“Sym”; numbered from 0 to 7) and extending over four PRBs, numbered 46, 47, 48, 49. PRBs 46 and 47 are assigned to LTE transmission and PRBs 48 and 49 are assigned to NR transmission. The LTE CRSs are muted in PRBs 48 and 49 whereas the LTE CRSs are boosted in PRBs 46 and 47.

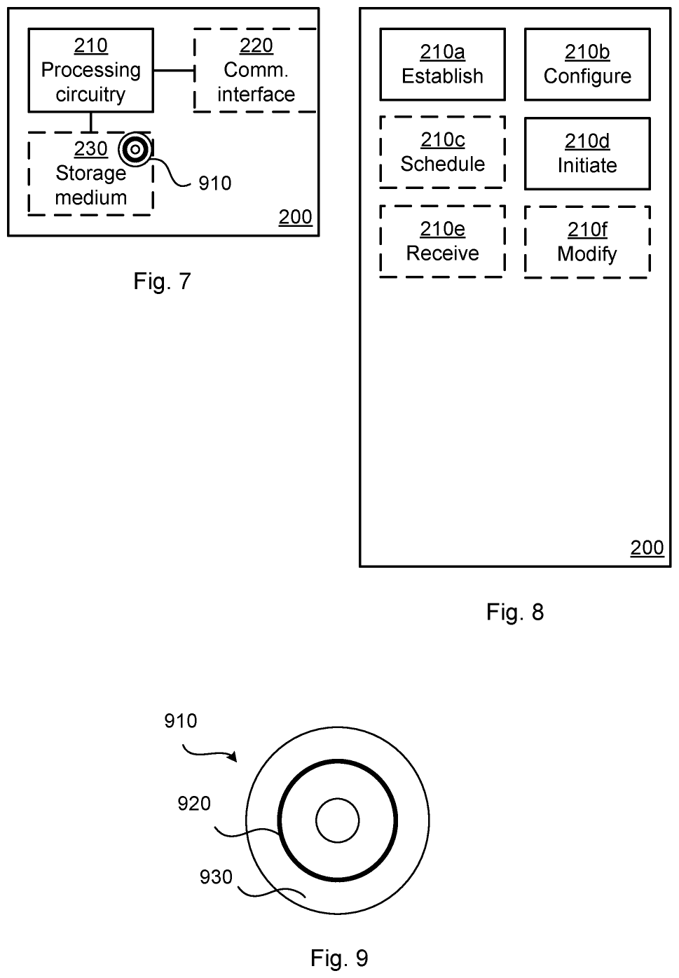

FIG. 7 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910 (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications interface 220 at least configured for communications with other entities, functions, nodes, and devices, such as the antenna system and its co-sited antenna arrays 140a, 140b and the core network 120. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 8 schematically illustrates, in terms of a number of functional modules, the components of a network node 200 according to an embodiment. The network node 200 of FIG. 8 comprises a number of functional modules; an establish module 210a configured to perform step S102, a configure module 210b configured to perform step S104, and an initiate module 210d configured to perform step S108. The network node 200 of FIG. 8 may further comprise a number of optional functional modules, such as any of a schedule module 210c configured to perform step S106, a receive module 210e configured to perform step S110, and a modify module 210f configured to perform step S112. In general terms, each functional module 210a:210f may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 8. It should also be mentioned that even though the modules correspond to parts of a computer program, they do not need to be separate modules therein, but the way in which they are implemented in software is dependent on the programming language used. Preferably, one or more or all functional modules 210a:210f may be implemented by the processing circuitry 210, possibly in cooperation with the communications interface 220 and/or the storage medium 230. The processing circuitry 210 may thus be configured to from the storage medium 230 fetch instructions as provided by a functional module 210a:210f and to execute these instructions, thereby performing any steps as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time.

Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 7 the processing circuitry 210 may be distributed among a plurality of devices, or nodes. The same applies to the functional modules 210a:210f of FIG. 8 and the computer program 920 of FIG. 9.

FIG. 9 shows one example of a computer program product 910 comprising computer readable storage medium 930. On this computer readable storage medium 930, a computer program 920 can be stored, which computer program 920 can cause the processing circuitry 210 and thereto operatively coupled entities and devices, such as the communications interface 220 and the storage medium 230, to execute methods according to embodiments described herein. The computer program 920 and/or computer program product 910 may thus provide means for performing any steps as herein disclosed.

In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

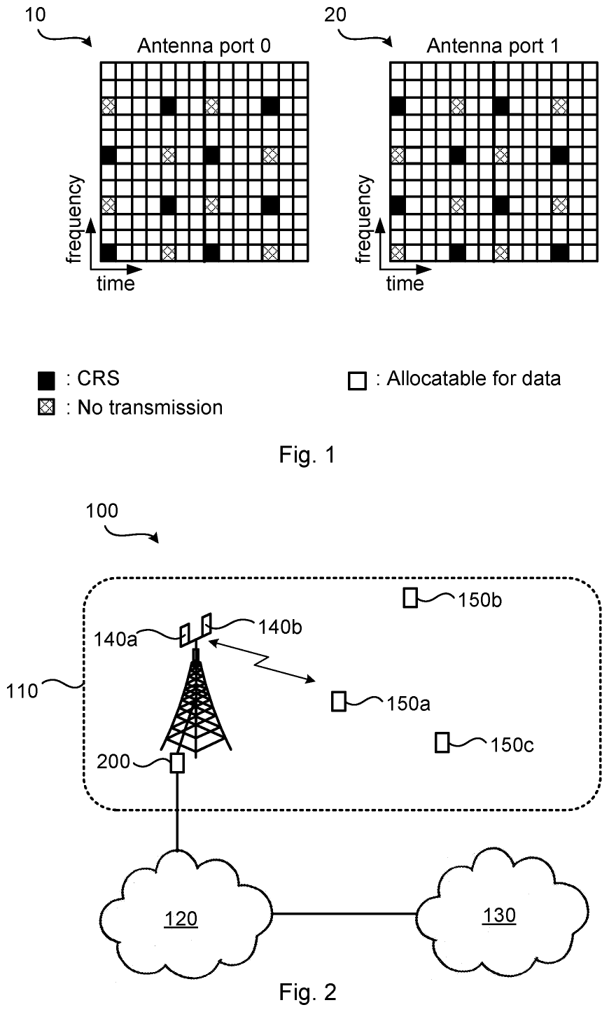

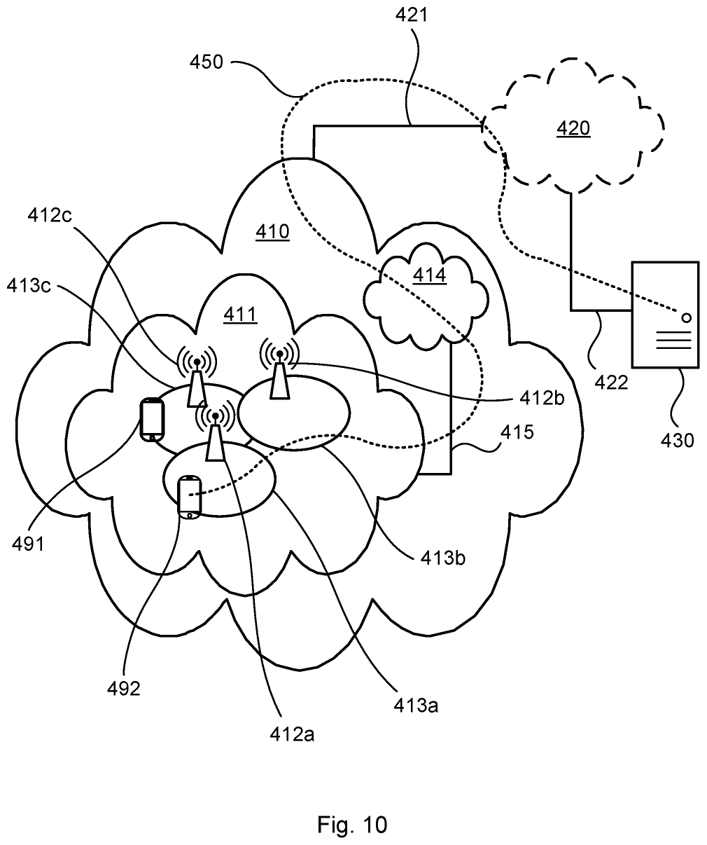

FIG. 10 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 200 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the terminal user equipment 150a, 150b, 150c of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 10 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

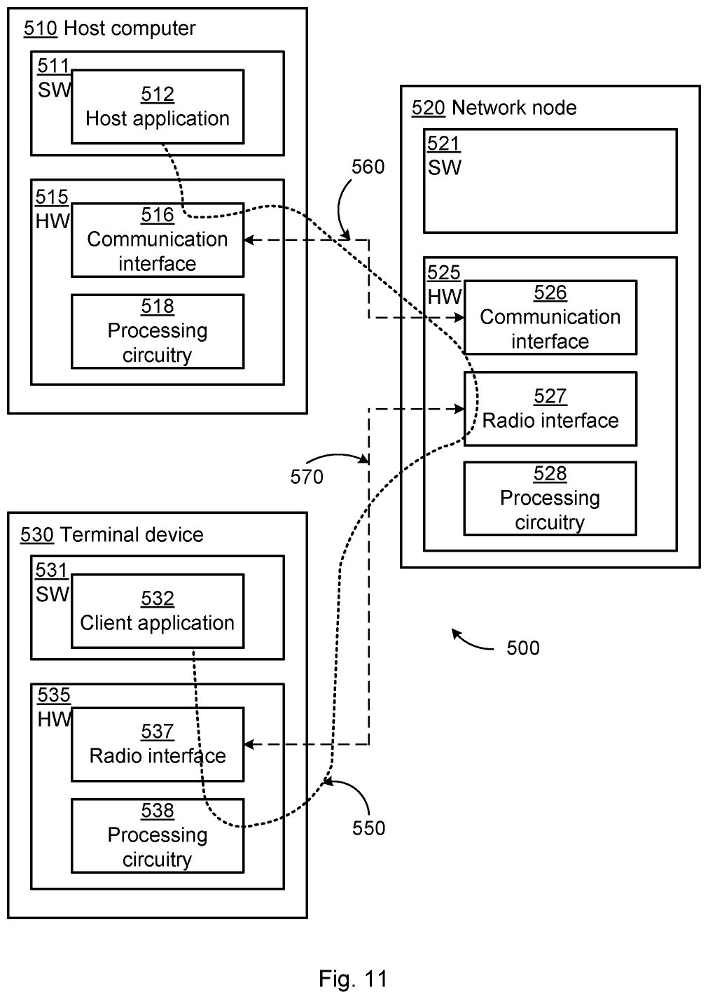

FIG. 11 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 11. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the user equipment 150a, 150b, 150c of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 200 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 11) served by radio access network node 520. Communication interface 526 may be configured to facilitate connection 560 to host computer 510. Connection 560 may be direct or it may pass through a core network (not shown in FIG. 11) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 11 may be similar or identical to host computer 430, one of network nodes 412a, 412b, 412c and one of UEs 491, 492 of FIG. 10, respectively. This is to say, the inner workings of these entities may be as shown in FIG. 11 and independently, the surrounding network topology may be that of FIG. 10.

In FIG. 11, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network). Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signaling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for transmission of a New Radio (NR) downlink data channel in a slot, the method being performed by a network node, the method comprising:
establishing a network connection for an NR user equipment over an NR air interface and configuring the NR user equipment with less than full Long Term Evolution-Common Reference Signals (LTE-CRS) rate matching;
configuring resource elements for NR transmission and resource elements for Long Term Evolution (LTE) transmission in the slot, wherein the NR data is allocated to the resource elements for NR transmission that correspond to the NR downlink data channel, and wherein any resource elements for LTE transmission that correspond to the NR downlink data channel are to be muted; and
initiating transmission of the slot.

2. The method according to claim 1, wherein the less than full LTE-CRS rate matching corresponds to no LTE-CRS rate matching or LTE-CRS rate matching in less than all available physical resource blocks (PRBs).

3. The method according to claim 1, wherein initiating the transmission of the slot comprises:
providing information of the configured resource elements for the NR transmission to a scheduler of the NR transmission; and
providing information of the configured resource elements for the LTE transmission to a scheduler of the LTE transmission.

4. The method according to claim 1, wherein the slot comprises symbols, and wherein initiating the transmission of the slot comprises:
initiating, for a transmitter of the NR transmission, transmission of the NR data in at least one resource block corresponding to the NR downlink data channel; and
initiating, for a transmitter of the LTE transmission, muting of LTE control information in said at least one symbol.

5. The method according to claim 1, wherein the slot is part of a non-multicast-broadcast single-frequency network (non-MBSFN) subframe.

6. The method according to claim 1, wherein the NR downlink data channel is an NR Physical Downlink Shared CHannel (PDSCH).

7. The method according to claim 1, wherein the NR downlink data channel covers a range of physical resource blocks (PRBs) and wherein the resource elements for LTE transmission that correspond to the NR downlink data channel are to be muted only for the specified range of PRBs.

8. The method according to claim 1, wherein the method further comprises:
receiving a channel state information report from an LTE user equipment over an LTE air interface, wherein the channel state information report is based on measurements in the slot; and
modifying the channel state information report.

9. The method according to a combination of claim 7 wherein the method further comprises:
receiving a channel state information report from an LTE user equipment over an LTE air interface, wherein the channel state information report is based on measurements in the slot; and
modifying the channel state information report, and
wherein, when the specified range of PRBs covers all PRBs, said modifying comprises any of:
reducing a weight assigned to the channel state information report,
ignoring the channel state information report,
reducing dependability of the channel state information report.

10. The method according to a combination of claim 7 wherein the method further comprises:
receiving a channel state information report from an LTE user equipment over an LTE air interface, wherein the channel state information report is based on measurements in the slot; and
modifying the channel state information report, and
wherein, when the specified range of PRBs covers less than all PRBs, said modifying comprises any of:
increasing a weight assigned to the channel state information report when based on measurements outside the specified range of PRBs in the slot,
ignoring any measurements in the channel state information report that depend on the resource elements for LTE transmission that are muted,
increasing a weight assigned to the channel state information report when based on measurements that do not depend on the resource elements that correspond to the NR downlink data channel.

11. The method according to claim 7, wherein, when the specified range of PRBs covers all PRBs, the method further comprises:
scheduling a-periodic channel state information measurements to be made by an LTE user equipment over an LTE air interface only outside the slot.

12. The method according to claim 1, wherein initiating the transmission of the slot comprises:
initiating boosting transmission power of LTE control information in at least one resource element for LTE transmission in the slot that does not correspond to the NR downlink data channel.

13. The method according to claim 12, wherein how much the transmission power of the LTE control information is boosted is proportional to how much the transmission power of the resource elements for LTE transmission that correspond to the NR downlink data channel is muted.

14. The method according to claim 1, wherein that the NR downlink data channel is allocated to the resource elements for NR transmission that correspond to the NR downlink data channel is a result of a scheduling decision taken for the LTE transmission and the NR transmission.

15. The method according to claim 1, wherein transmission of the slot is initiated from co-sited antennas, and wherein the resource elements for LTE transmission and the resource elements for NR transmission are to be transmitted from the co-sited antennas.

16. The method according to claim 15, wherein the resource elements of LTE transmission and the resource elements for NR transmission are combined on each antenna of the co-sited antennas.

17. The method according to claim 15, wherein the resource elements for LTE transmission are transmitted from a first antenna of the co-sited antennas and the resource elements for NR transmission are transmitted from a second antenna of the co-sited antennas.

18. A network node for transmission of a New Radio (NR) downlink data channel in a slot, the network node comprising processing circuitry, the processing circuitry being configured to cause the network node to:
establish a network connection for an NR user equipment over an NR air interface and configuring the NR user equipment with less than full Long Term Evolution-Common Reference Signals (LTE-CRS) rate matching;
configure resource elements for NR transmission and resource elements for Long Term Evolution (LTE) transmission in the slot, wherein the NR data is allocated to the resource elements for NR transmission that correspond to the NR downlink data channel, and wherein any resource elements for LTE transmission that correspond to the NR downlink data channel are to be muted; and
initiate transmission of the slot.

19. (canceled)

20. The network node according to claim 18, wherein the less than full LTE-CRS rate matching corresponds to no LTE-CRS rate matching or LTE-CRS rate matching in less than all available physical resource blocks, PRBs.

21. A non-transitory computer readable storage medium comprising a computer program for transmission of a New Radio (NR) downlink data channel in a slot, the computer program comprising computer code which, when run on processing circuitry of a network node, causes the network node to:
establish a network connection for an NR user equipment over an NR air interface and configuring the NR user equipment with less than full Long Term Evolution-Common Reference Signals (LTE-CRS) rate matching;
configure resource elements for NR transmission and resource elements for Long Term Evolution (LTE) transmission in the slot, wherein the NR data is allocated to the resource elements for NR transmission that correspond to the NR downlink data channel, and wherein any resource elements for LTE transmission that correspond to the NR downlink data channel are to be muted; and
initiate transmission of the slot.

22. (canceled)
